(19) United States
(12) Patent Application Publication
(10) Pub. No.: US 2025/0149261 A1
(43) Pub. Date: May 8, 2025

(54) SOLID ELECTROLYTIC CAPACITOR AND CAPACITOR ARRAY

(71) Applicant: Murata Manufacturing Co., Ltd., Nagaokakyo-shi (JP)

(72) Inventors: Katsuhiko TOKUDA, Nagaokakyo-shi (JP); Takeshi FURUKAWA, Nagaokakyo-shi (JP)

(21) Appl. No.: 19/004,799

(22) Filed: Dec. 30, 2024

Related U.S. Application Data
(63) Continuation of application No. PCT/JP2023/023597, filed on Jun. 26, 2023.

(30) Foreign Application Priority Data
Jul. 6, 2022 (JP) 2022-109097

(51) Int. Cl. H01G 9/26; H01G 9/15

(52) U.S. Cl. CPC H01G 9/26; H01G 9/15

(57) ABSTRACT

A solid electrolytic capacitor that includes: an anode plate including a porous layer at least on at least one a main surface thereof; a dielectric layer on a surface of the porous layer; a solid electrolyte layer on a surface of the dielectric layer; a conductor layer on a surface of the solid electrolyte layer; and an insulating layer on the surface of the dielectric layer, wherein the insulating layer covers at least a part of an end portion of the solid electrolyte layer in a region surrounding the solid electrolyte layer.

### CROSS REFERENCE TO RELATED APPLICATIONS

The present application is a continuation of International application No. PCT/JP2023/023597, filed Jun. 26, 2023, which claims priority to Japanese Patent Application No. 2022-109097, filed Jul. 6, 2022, the entire contents of each of which are incorporated herein by reference.

### TECHNICAL FIELD

The present disclosure relates to a solid electrolytic capacitor and a capacitor array.

### BACKGROUND ART

Patent Document 1 discloses a solid electrolytic capacitor built-in substrate in which a sheet-shaped solid electrolytic capacitor whose anode is an aluminum metal layer having a porous portion and whose cathode is a silver paste layer is built in an insulating resin. A front layer and a back layer of the solid electrolytic capacitor built-in substrate are each made of a metal layer, the anode is connected to the metal layers of the front layer and the back layer with a through hole interposed therebetween, and the cathode is connected to the metal layer of the front layer by using a conductor.

For example, in FIGS. 1 and 3 of Patent Document 1, a porous portion 2 is formed by making one side of an aluminum anode 1 porous by a treatment with a chemical solution, a solid electrolyte layer 5 that is a conductive polymer layer is formed so as to cover an exposed part of the porous portion 2, and a cathode 6 made of a Ag paste layer is formed on the solid electrolyte layer 5. In the porous portion 2, on a surface of the anode 1, a dielectric made of aluminum oxide 16 is formed, and electrical insulation is made between the anode 1 and the solid electrolyte layer 5 and between the anode 1 and the cathode 6; thus, a solid electrolytic capacitor element is formed. This solid electrolytic capacitor is built in an insulating resin 3, the front layer and the back layer are each made of a metal layer 4 constituted by a wiring pattern, the anode 1 is connected to the metal layers 4 of the front layer and the back layer with a through hole 8 interposed therebetween, and the cathode 6 is connected to the metal layer 4 by using a conductor 7.
Patent Document 1: Japanese Unexamined Patent Application Publication No. 2007-251101

### SUMMARY OF THE DISCLOSURE

Patent Document 1 discloses a technique of manufacturing a small low-impedance electrolytic capacitor by building a capacitor in a core substrate. However, consideration by the present inventors has made it clear that ensuring process likelihood and achieving fine pattern layout are difficult because building the capacitor in the core substrate has problems of, for example, the risk of causing a short circuit in providing a conductive layer, and difficulty in providing a conductive path in a limited conductive layer space.

For example, in FIGS. 1 and 3 of Patent document 1, although a surface of the porous portion 2 is covered entirely with the dielectric made of the aluminum oxide 16, a spot of the surface of the porous portion 2 not being covered with the dielectric may exist depending on the accuracy of the manufacturing process. In such a case, when the formation range of the cathode 6 is made larger than the solid electrolyte layer 5 to expand the range in which the conductor 7 corresponding to a via conductor can be provided, a spot of the surface of the porous portion 2 not being covered with the dielectric and the cathode 6 are in contact with each other, which poses the risk of causing a short circuit.

Reducing the above-described risk of causing a short circuit creates a need to provide the cathode 6 in a relatively small range. However, the range in which the conductor 7 can be provided is limited in this case.

As describe above, there is room for improvement in the related art in view of ensuring the flexibility in installation spot of the via conductor while reducing the risk of causing a short circuit.

The present disclosure has been made to solve the above-described problems, and an object of the present disclosure is to provide a solid electrolytic capacitor capable of ensuring the flexibility in installation spot of a via conductor while reducing the risk of causing a short circuit. Another object of the present disclosure is to provide a capacitor array including the above-described solid electrolytic capacitor.

A solid electrolytic capacitor of the present disclosure includes: an anode plate including a porous layer at least on at least one a main surface thereof; a dielectric layer on a surface of the porous layer; a solid electrolyte layer on a surface of the dielectric layer; a conductor layer on a surface of the solid electrolyte layer; and an insulating layer on the surface of the dielectric layer, wherein the insulating layer covers at least a part of an end portion of the solid electrolyte layer in a region surrounding the solid electrolyte layer.

A capacitor array of the present disclosure includes a plurality of the solid electrolytic capacitors of the present disclosure.

According to the present disclosure, there can be provided the solid electrolytic capacitor capable of ensuring the flexibility in installation spot of a via conductor while reducing the risk of causing a short circuit. In addition, according to the present disclosure, there can be provided the capacitor array including the above-described solid electrolytic capacitor.

### BRIEF DESCRIPTION OF THE DRAWINGS

FIG. 1 is a schematic plan view illustrating one example of a solid electrolytic capacitor of Embodiment 1 of the present disclosure.

FIG. 2 is a schematic sectional view illustrating one example of a section taken along a line segment A1-A2 of the solid electrolytic capacitor illustrated in FIG. 1.

FIG. 3A is a schematic sectional view illustrating one example of a section taken along a line segment B1-B2 of the solid electrolytic capacitor illustrated in FIG. 2. FIG. 3B is a schematic sectional view illustrating another example of the section taken along the line segment B1-B2 of the solid electrolytic capacitor illustrated in FIG. 2.

FIG. 4 is a schematic sectional view illustrating one example of a solid electrolytic capacitor of Embodiment 2 of the present disclosure.

FIG. 5 is a schematic sectional view illustrating one example of a solid electrolytic capacitor of Embodiment 3 of the present disclosure.

FIG. 6 is a schematic sectional view illustrating one example of a solid electrolytic capacitor of Embodiment 4 of the present disclosure.

FIG. 7 is a schematic sectional view illustrating one example of a solid electrolytic capacitor of Embodiment 5 of the present disclosure.

FIG. 8 is a schematic sectional view illustrating one example of a solid electrolytic capacitor of Embodiment 6 of the present disclosure.

FIG. 9 is a schematic perspective view illustrating one example of a capacitor array of Embodiment 7 of the present disclosure.

FIG. 10 is a schematic sectional view illustrating one example of a section taken along a line segment C1-C2 of the capacitor array illustrated in FIG. 9.

### DESCRIPTION OF THE PREFERRED EMBODIMENTS

Hereinafter, a solid electrolytic capacitor of the present disclosure and a capacitor array of the present disclosure will be described. Note that the present disclosure is not limited to the configurations below, and a change may be made appropriately without departing from the spirit of the present disclosure. The present disclosure also includes a combination of the preferred individual configurations described below.

Note that each of the embodiments below is an example, and configurations presented in the different embodiments may be partially replaced or combined. In Embodiment 2 and the subsequent embodiments, description of the items common to Embodiment 1 will be omitted, and differences will be mainly described. In particular, similar actions and effects exhibited by similar configurations will not be referred to one by one in every embodiment.

In the following description, when no particular distinction is made among the embodiments, a “solid electrolytic capacitor of the present disclosure” and a “capacitor array of the present disclosure” are simply used.

The figures given below are schematic views, and, for example, the dimensions and the scale of aspect ratio given in the figures may be different from those of an actual product. In the figures, the same or corresponding parts are denoted by the same reference signs. In the figures, the same components are denoted by the same reference sings, and redundant description will be omitted.

### Embodiment 1

The solid electrolytic capacitor of the present disclosure includes: an anode plate including a porous layer at least on at least one a main surface thereof; a dielectric layer on a surface of the porous layer; a solid electrolyte layer on a surface of the dielectric layer; a conductor layer on a surface of the solid electrolyte layer; and an insulating layer on the surface of the dielectric layer, wherein the insulating layer covers at least a part of an end portion of the solid electrolyte layer in a region surrounding the solid electrolyte layer.

Hereinafter, one example of the solid electrolytic capacitor of the present disclosure will be described as a solid electrolytic capacitor of Embodiment 1 of the present disclosure.

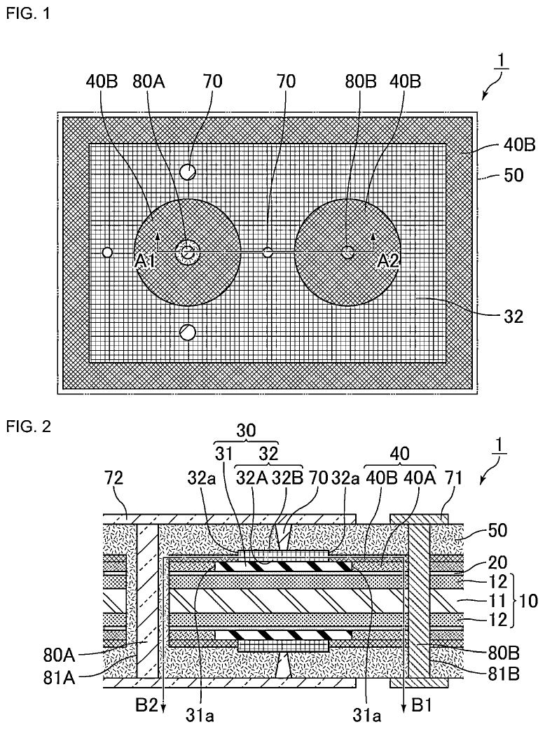

FIG. 1 is a schematic plan view illustrating one example of the solid electrolytic capacitor of Embodiment 1 of the present disclosure. FIG. 2 is a schematic sectional view illustrating one example of a section taken along a line segment A1-A2 of the solid electrolytic capacitor illustrated in FIG. 1.

A solid electrolytic capacitor 1 illustrated in FIGS. 1 and 2 includes an anode plate 10, a dielectric layer 20, a solid electrolyte layer 31, a conductor layer 32, and an insulating layer 40.

The anode plate 10 includes a core 11 and a porous layer 12.

Herein, examples of such a “plate” include “sheet”, “foil”, and “film” that are not distinguished by thickness.

The core 11 is made of a metal, preferably a valve-action metal. In the case of the core 11 made of such a valve-action metal, the anode plate 10 is also referred to as a valve-action metal base.

Examples of the valve-action metal include metal simple substances such as aluminum, tantalum, niobium, titanium, and zirconium and an alloy containing at least one kind of such metal simple substances. Aluminum or an aluminum alloy is preferable.

The porous layer 12 is provided at least on a main surface on one side of the core 11. That is, the porous layer 12 may be provided only on the main surface on one side of the core 11 or may be provided on each of the main surfaces on both sides of the core 11 as illustrated in FIG. 2. As described above, the anode plate 10 includes the porous layer 12 at least on a main surface on one side of the anode plate 10. Thus, the surface area of the anode plate 10 is increased, which can facilitate improvement in the capacitance of the solid electrolytic capacitor 1.

The porous layer 12 is preferably an etched layer formed by etching a surface of the anode plate 10.

The shape of the anode plate 10 is preferably a flat plate shape, more preferably a foil shape. Thus, herein, examples of such a “plate shape” also include a “foil shape”. Herein, examples of the “plate shape” also include a “sheet shape” and a “film shape”.

The dielectric layer 20 is provided on a surface of the porous layer 12. Although simplified in the figures, more specifically, the dielectric layer 20 is provided along surfaces (outlines) of pores in the porous layer 12.

The dielectric layer 20 is preferably made of an oxide film of the above-described valve-action metal. For example, in the case of the anode plate 10 made of an aluminum foil, the oxide film to be the dielectric layer 20 is formed by performing an anodic oxidation treatment (also referred to as a chemical conversion treatment) on the anode plate 10 in an aqueous solution containing, for example, ammonium adipate. Since the dielectric layer 20 is formed along the surface of the porous layer 12, the dielectric layer 20 has pores (recessed portions).

The solid electrolyte layer 31 is provided on a surface of the dielectric layer 20. The conductor layer 32 is provided on a surface of the solid electrolyte layer 31.

In FIG. 2, a cathode layer 30 includes the solid electrolyte layer 31 provided on the surface of the dielectric layer 20 and the conductor layer 32 provided on the surface of the solid electrolyte layer 31. The cathode layer 30 is provided on the surface of the dielectric layer 20. More specifically, the cathode layer 30 is provided, on the surface of the dielectric layer 20, in a region surrounded by the insulating layer 40.

Examples of a material constituting the solid electrolyte layer 31 include conductive polymers such as polypyrroles, polythiophenes, and polyanilines.

Polythiophenes are preferable, and poly(3,4-ethylenedioxythiophene) (PEDOT) is particularly preferable. The conductive polymers may contain a dopant such as polystyrene sulfonate (PSS).

The solid electrolyte layer 31 may be formed in a predetermined region including an inner part of a pore of the dielectric layer 20 by, for example, a method in which a dispersion of a conductive polymer such as poly(3,4-ethylenedioxythiophene) is coated on the surface of the dielectric layer 20 and is dried, or a method in which a polymerized film of, for example, poly(3,4-ethylenedioxythiophene) is formed on the surface of the dielectric layer 20 by using a treatment liquid containing a polymerizable monomer such as 3,4-ethylenedioxythiophene.

The conductor layer in the solid electrolytic capacitor of the present disclosure preferably includes a metal layer containing a metal filler.

The conductor layer 32 preferably includes a metal layer containing a metal filler.

The metal filler is preferably at least one kind selected from the group consisting of a copper filler, a silver filler, and a nickel filler.

The metal layer may be, for example, a metal plating film or a metal foil. In this case, the metal layer is preferably made of at least one kind of metal selected from the group consisting of copper, silver, nickel, and an alloy containing at least one kind of such metals as a main component.

Herein, a main component refers to an element component having the largest weight proportion.

The conductor layer 32 preferably further includes a conductive resin layer in addition to the metal layer.

Examples of the conductive resin layer include a conductive adhesive layer containing at least one kind of conductive filler selected from the group consisting of a copper filler, a silver filler, a nickel filler, and a carbon filler.

Note that the conductor layer 32 may include only the metal layer, may include only the conductive resin layer, or may include both the metal layer and the conductive resin layer.

In the example illustrated in FIGS. 1 and 2, the conductor layer 32 includes a first conductor layer 32A provided on the surface of the solid electrolyte layer 31 and a second conductor layer 32B provided on a surface of the first conductor layer 32A. Thus, the conductor layer 32 preferably includes plural kinds of conductor layers.

Leaking current is likely to be a problem in the solid electrolytic capacitor because the dielectric layer has a small thickness. For such a problem, since the conductor layer 32 includes plural kinds of conductor layers such as the first conductor layer 32A and the second conductor layer 32B, plural bulk resistances and interface resistances exist in the cathode layer 30, and leaking current can thereby be easily suppressed.

The first conductor layer 32A is preferably a conductive resin layer containing a conductive filler.

The second conductor layer 32B is preferably a metal layer containing a metal filler.

The conductor layer 32 may include, for example, a carbon layer serving as the first conductor layer 32A and a copper layer serving as the second conductor layer 32B.

The carbon layer is formed in a predetermined region, for example, by coating the surface of the solid electrolyte layer 31 with a carbon paste containing a carbon filler by, for example, sponge transfer, screen printing, dispenser coating, or inkjet printing.

The copper layer is formed in a predetermined region, for example, by coating a surface of the carbon layer with a copper paste containing a copper filler by, for example, sponge transfer, screen printing, spray coating, dispenser coating, or inkjet printing.

A capacitor portion in the solid electrolytic capacitor 1 is constituted by the anode plate 10, the dielectric layer 20, and the cathode layer 30.

The insulating layer 40 is made of an insulating material.

Examples of the insulating material constituting the insulating layer 40 include polyphenyl sulfone (PPS), polyether sulfone (PES), cyanate ester resins, fluorine resins (such as tetrafluoroethylene and tetrafluoroethylene-perfluoroalkyl vinyl ether copolymers), a composition made of a soluble polyimide siloxane and an epoxy resin, polyimide resins, and polyamide-imide resins, and derivatives and precursors thereof.

The insulating layer 40 is provided on the surface of the dielectric layer 20. The insulating layer 40 is provided so as to cover at least a part of an end portion of the solid electrolyte layer 31 in a region surrounding the solid electrolyte layer 31. The insulating layer 40 is provided on a peripheral edge of the cathode layer 30. The insulating layer 40 may be provided so as to cover at least a part of an end portion of the conductor layer 32 but is preferably provided so as not to cover the end portion of the conductor layer 32.

In FIG. 2, the insulating layer 40 includes a first insulating layer 40A provided on the surface of the dielectric layer 20 in a region surrounding the solid electrolyte layer 31 and a second insulating layer 40B provided on a surface of the first insulating layer 40A, and the second insulating layer 40B is provided so as to cover at least a part of the end portion of the solid electrolyte layer 31. With the configuration in which the insulating layer includes the first insulating layer provided on the surface of the dielectric layer in a region surrounding the solid electrolyte layer and the second insulating layer provided on the surface of the first insulating layer, and the second insulating layer is provided so as to cover at least a part of the end portion of the solid electrolyte layer as described above, the first insulating layer and the second insulating layer can be provided separately, and the flexibility in the arrangement of each layer included in the solid electrolytic capacitor is thus improved.

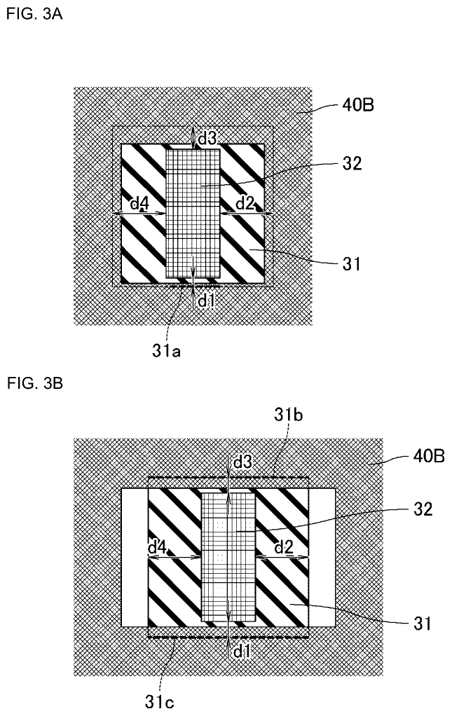

FIG. 3A is a schematic sectional view illustrating one example of a section taken along a line segment B1-B2 of the solid electrolytic capacitor illustrated in FIG. 2. FIG. 3B is a schematic sectional view illustrating another example of the section taken along the line segment B1-B2 of the solid electrolytic capacitor illustrated in FIG. 2.

In FIG. 3A, the second insulating layer 40B constituting the insulating layer is provided so as to cover the entire end portion of the solid electrolyte layer 31. On the other hand, in FIG. 3B, the second insulating layer 40B constituting the insulating layer is provided so as to cover a part of the end portion of the solid electrolyte layer 31.

In plan view in a thickness direction, the insulating layer is preferably provided so as to cover at least a part of the end portion of the solid electrolyte layer at which a length from the end portion of the solid electrolyte layer to the end portion of the conductor layer is the shortest. The risk of causing a short circuit is maximized at the part, of the end portion of the solid electrolyte layer, at which the length from the end portion of the solid electrolyte layer to the end portion of the conductor layer is the shortest, and the risk of causing a short circuit can thereby be further reduced by providing the insulating layer in a way of covering at least the part.

Herein, the end portion of the solid electrolyte layer refers to an outer edge of the solid electrolyte layer in the plan view of the solid electrolyte layer in the thickness direction. The same applies to end portions of other constituents.

Herein, the expression “the insulating layer covers at least a part of the end portion of the solid electrolyte layer” means that the insulating layer is provided on the solid electrolyte layer in the plan view of the solid electrolyte layer in the thickness direction. The same applies to the cases of other constituents.

Herein, the thickness direction refers to the thickness direction of the solid electrolytic capacitor and is determined as, for example, in FIG. 2, an up-down direction and as, in FIGS. 3A and 3B, a depth direction of the sheet of paper of each of the figures.

In FIG. 3A, the length from the end portion of the solid electrolyte layer 31 to the end portion of the conductor layer 32 refers to each of the lengths denoted by d1, d2, d3, and d4 in FIG. 3A. In FIG. 3A, between d1, d2, d3, and d4, d1 is the shortest, and, in plan view in the thickness direction the part of the end portion of the solid electrolyte layer 31 at which the length from the end portion of the solid electrolyte layer 31 to the end portion of the conductor layer 32 is the shortest is thus the part of the end portion of the solid electrolyte layer 31 denoted by 31a in FIG. 3A.

Thus, in FIG. 3A, the second insulating layer 40B is preferably provided so as to cover at least the end portion 31a of the solid electrolyte layer 31.

In the case where the planar shape of the solid electrolyte layer is quadrilateral when viewed in the thickness direction, in plan view in the thickness direction, the insulating layer is preferably provided so as to cover at least a side, among all sides of the solid electrolyte layer, including a part at which the length from the end portion of the solid electrolyte layer to the end portion of the conductor layer is the shortest. In the sides of the solid electrolyte layer, the risk of causing a short circuit is maximized at the side including the part at which the length from the end portion of the solid electrolyte layer to the end portion of the conductor layer is the shortest, and the risk of causing a short circuit can thereby be further reduced by providing the insulating layer in a way of covering at least the part.

In FIG. 3B, the planar shape of the solid electrolyte layer 31 is quadrilateral when viewed in the thickness direction. In FIG. 3B, between d1, d2, d3, and d4, d1 and d3 are the shortest, and, in plan view in the thickness direction, the side, of the sides of the solid electrolyte layer 31, including the part at which the length from the end portion of the solid electrolyte layer 31 to the end portion of the conductor layer 32 is the shortest is thus each of the sides of the solid electrolyte layer 31 denoted by 31b and 31c in FIG. 3B.

Thus, in FIG. 3B, the second insulating layer 40B is preferably provided so as to cover at least the sides 31b and 31c of the solid electrolyte layer 31.

In FIG. 3A, the second insulating layer 40B is provided so as to cover the entire end portion of the solid electrolyte layer 31 in plan view in the thickness direction. As in FIG. 3A, the insulating layer is most preferably provided so as to cover the entire end portion of the solid electrolyte layer in plan view in the thickness direction. Such a configuration can further reduce the risk of causing a short circuit.

For example, by coating a portion of the surface of the dielectric layer 20 overlapping the peripheral edge of the solid electrolyte layer 31 with an insulating material, the insulating layer 40 is formed, at the peripheral edge of the solid electrolyte layer 31 so as to surround a region in which the conductor layer 32 is formed or is to be formed.

Examples of the insulating material constituting the first insulating layer 40A and the second insulating layer 40B include polyphenyl sulfone, polyether sulfone, cyanate ester resins, fluorine resins (such as tetrafluoroethylene and tetrafluoroethylene-perfluoroalkyl vinyl ether copolymers), a composition made of a soluble polyimide siloxane and an epoxy resin, polyimide resins, and polyamide-imide resins, and derivatives and precursors thereof.

The insulating material constituting the first insulating layer 40A may be the same as or different from the insulating material constituting the second insulating layer 40B.

The first insulating layer 40A may be constituted by the same resin as a sealing layer 50, which will be described layer. Unlike the sealing layer 50, an inorganic filler may adversely affect an effective portion of the solid electrolytic capacitor 1 when contained in the first insulating layer 40A, and the first insulating layer 40A is thus preferably made of resin alone.

The thickness of the first insulating layer 40A may be the same as, larger than, or smaller than the thickness of the second insulating layer 40B.

The thickness of the first insulating layer 40A may be the same as, larger than, or smaller than the thickness of the solid electrolyte layer 31.

The thickness of the second insulating layer 40B may be the same as, larger than, or smaller than the thickness of the conductor layer 32.

The solid electrolytic capacitor 1 preferably further includes the sealing layer 50.

The sealing layer 50 includes a resin material.

Examples of the resin material included in the sealing layer 50 include epoxy, phenol, and polyimide.

The sealing layer 50 may further contain, in addition to the resin material, an inorganic filler of, for example, silica or alumina.

The sealing layer 50 may be constituted by only one layer or two layers or more.

The sealing layer 50 covers the conductor layer 32. In the example illustrated in FIG. 2, the sealing layer 50 further covers the insulating layer 40 in addition to the conductor layer 32.

In the solid electrolytic capacitor 1, by providing the sealing layer 50 covering the conductor layer 32, deformation due to external force is suppressed, and delamination is also suppressed from occurring, accordingly. By forming the solid electrolytic capacitor in a way of including the sealing layer that includes the resin material and covers the conductor layer, deformation due to external force is suppressed, and delamination is also suppressed from occurring, accordingly.

The sealing layer 50 may be provided such that a portion of the anode plate 10, particularly an end face of the core 11, is exposed from the sealing layer 50. In this case, even with the sealing layer 50, the anode plate 10 can be connected to the outside of the sealing layer 50.

The sealing layer 50 is formed in a predetermined region by, for example, a method in which a resin sheet is stuck so as to cover the conductor layer 32 or a method in which a resin paste is coated so as to cover the conductor layer 32.

The solid electrolytic capacitor 1 preferably further includes a via conductor 70.

The via conductor 70 is provided so as to extend, in the thickness direction, from a surface of the sealing layer 50 to the cathode layer 30, more specifically, from the surface of the sealing layer 50 to the second conductor layer 32B. Thus, the cathode layer 30 is electrically led outside the sealing layer 50 by using the via conductor 70 and can be electrically connected to the outside of the sealing layer 50.

The via conductor 70 is connected to a cathode wiring pattern 72 provided on the surface of the sealing layer 50.

Examples of a material constituting the via conductor 70 include low-resistance metals such as silver, gold, and copper.

The via conductor 70 is formed as follows, for example. First, a hole extending, in the thickness direction, from the surface of the sealing layer 50 to the cathode layer 30, here, from the surface of the sealing layer 50 to the second conductor layer 32B is provided in the sealing layer 50 by performing, for example, drill processing or laser processing. Then, the via conductor 70 is formed by plating an inner wall surface of the hole provided in the sealing layer 50 or by filling the hole with a conductive paste and then performing a heat treatment.

The solid electrolytic capacitor 1 preferably further includes at least one of through hole conductors 80A and 80B.

The through hole conductors 80A and 80B pass through the sealing layer 50 in the thickness direction. In the example illustrated in FIG. 2, the through hole conductors 80A and 80B pass through, in addition to the sealing layer 50, the anode plate 10 (the core 11), the dielectric layer 20, and the insulating layer 40 in the thickness direction.

With such a through hole conductor passing through the sealing layer in the thickness direction, an electrical function is imparted to the sealing layer 50.

The through hole conductor 80A is preferably provided at least on an inner wall surface of a through hole 81A passing through the sealing layer 50 in the thickness direction. In the example illustrated in FIG. 2, the through hole conductor 80A is provided in the entire inner part of the through hole 81A.

The through hole conductor 80A is electrically insulated from the anode plate 10. As FIG. 2 illustrates, a space between the through hole conductor 80A and the anode plate 10 is preferably filled with an insulating material, for example, of the sealing layer 50.

The through hole conductor 80A is connected to the cathode wiring pattern 72 provided on the surface of the sealing layer 50. Thus, the through hole conductor 80A is electrically connected to the cathode layer 30 with the cathode wiring pattern 72 and the via conductor 70 interposed therebetween.

The through hole conductor 80B is preferably provided at least on an inner wall surface of a through hole 81B passing through the sealing layer 50 in the thickness direction. In the example illustrated in FIG. 2, the through hole conductor 80B is provided in the entire inner part of the through hole 81B.

The through hole conductor 80B is electrically connected to the anode plate 10. As FIG. 2 illustrates, the through hole conductor 80B is preferably electrically connected to the anode plate 10 at the inner wall surface of the through hole 81B. More specifically, the through hole conductor 80B is preferably electrically connected to an end face, of the anode plate 10, opposite to the inner wall surface of the through hole 81B in a direction orthogonal to the thickness direction. In the example illustrated in FIG. 2, the through hole conductor 80B is connected to the end face of the anode plate 10, particularly to an end face of the core 11. Thus, the anode plate 10 is electrically led outside by using the through hole conductor 80B. That is, an electrical function of electrically leading the anode plate 10 outside is imparted to the sealing layer 50. The through hole conductor 80B is connected to an anode wiring pattern 71 provided on the surface of the sealing layer 50.

The through hole conductor 80B is preferably electrically connected to the anode plate 10 throughout the circumference of the through hole 81B when viewed in the thickness direction. With such a configuration, the connection resistance between the through hole conductor 80B and the anode plate 10 can be easily reduced, and the equivalent series resistance of the solid electrolytic capacitor 1 can thereby be easily reduced.

The through hole conductor 80A is formed as follows, for example. First, a through hole passing through the anode plate 10 (the core 11), the dielectric layer 20, and the insulating layer 40 in the thickness direction is provided by performing, for example, drill processing or laser processing. Next, the above-described through hole is filled with an insulating material by forming the sealing layer 50. The through hole 81A passing through the sealing layer 50 in the thickness direction is provided by performing, for example, drill processing or laser processing on the part that has been filled with the insulating material. Here, by making the diameter of the through hole 81A smaller than the diameter of the through hole filled with the insulating material, the insulating material exists, in a planar direction, between an inner wall surface of the through hole formed prior to the through hole 81A and an inner wall surface of the through hole 81A. Then, the inner wall surface of the through hole 81A is metalized with a low-resistance metal such as copper, gold, or silver to form the through hole conductor 80A. In forming the through hole conductor 80A, for example, processing is facilitated by metalizing the inner wall surface of the through hole 81A by, for example, electroless copper plating or electrolytic copper plating. Note that the method for forming the through hole conductor 80A may be, other than the method in which the inner wall surface of the through hole 81A is metalized, a method in which the through hole 81A is filled with, for example, a metal or a composite material of metal and resin.

The through hole conductor 80B is formed as follows, for example. First, the through hole 81B passing through the sealing layer 50, the anode plate 10 (the core 11), the dielectric layer 20, and the insulating layer 40 in the thickness direction is provided by performing, for example, drill processing or laser processing. Then, the inner wall surface of the through hole 81B is metalized with a low-resistance metal such as copper, gold, or silver to form the through hole conductor 80B. In forming the through hole conductor 80B, processing is facilitated, for example, by metalizing the inner wall surface of the through hole 81B by, for example, electroless copper plating or electrolytic copper plating. Note that the method for forming the through hole conductor 80B may be, other than the method in which the inner wall surface of the through hole 81B is metalized, a method in which the through hole 81B is filled with, for example, a metal or a composite material of metal and resin.

In the solid electrolytic capacitor 1, the insulating layer 40 is provided so as to cover at least a part of the end portion of the solid electrolyte layer 31, in a region surrounding the solid electrolyte layer 31. More specifically, the insulating layer 40 is provided so as to cover the entire end portion of the solid electrolyte layer 31 in plan view in the thickness direction. Thus, the conductor layer 32 can be suppressed from entering between the solid electrolyte layer 31 and the insulating layer 40 and from being in contact with a spot of the surface of the porous layer 12 not being covered with the dielectric layer 20, thereby reducing the risk of causing a short circuit due to the conductor layer 32. In addition, the conductor layer 32 can be provided at least up to the position where the insulating layer 40 is provided, the flexibility in installation spot of the conductor layer 32 can be ensured, and, as a result, the flexibility in installation spot of the via conductor 70 can also be ensured. As described above, in the solid electrolytic capacitor 1, while the risk of causing a short circuit can be reduced, the flexibility in installation spot of the via conductor can be ensured; thus, ensuring process likelihood and fine pattern layout that are hardly achieved by the related art can be achieved. In addition, for example, the specific resistance can be lowered due to expansion of the range in which the via conductor can be provided, and the element size can be reduced by an amount equivalent to one channel of the capacitor array.

The insulating layer 40 includes the first insulating layer 40A and the second insulating layer 40B in the example illustrated in FIG. 2 but may include another layer other than the first insulating layer 40A and the second insulating layer 40B.

The planar shape of the solid electrolyte layer 31 is quadrilateral (square) when viewed in the thickness direction but may be other shapes including, for example, a quadrilateral other than a square, such as a rectangle, a polygon other than a square, a circle, and an ellipse.

In the example illustrated in FIGS. 3A and 3B, the planar shape of the solid electrolyte layer 31 is quadrilateral (square) when viewed in the thickness direction but may be other shapes including, for example, a quadrilateral other than a square, such as a rectangle, a polygon other than a square, a circle, and an ellipse.

The solid electrolytic capacitor 1 is manufactured by, for example, the following method.

First, the anode plate 10 including the porous layers 12 on both the main surfaces of the core 11, that is, the anode plate 10 including the porous layers 12 in both the main surfaces thereof is prepared. Then, an oxide film to be the dielectric layer 20 is formed on the surface of each of the porous layers 12 by performing an anodic oxidation treatment on the anode plate 10.

Next, the surface of the dielectric layer 20 is coated with an insulating material to form the first insulating layer 40A in a way of surrounding a region in which the solid electrolyte layer 31 is to be formed.

Then, in the region surrounded by the first insulating layer 40A, a treatment of coating the surface of the dielectric layer 20 with a conductive polymer dispersion and drying is repeated plural times to form the solid electrolyte layer 31.

Next, the surface of the first insulating layer 40A is coated with an insulating material to form the second insulating layer 40B in a way of covering the entirety or a part of the end portion of the solid electrolyte layer 31 in plan view in the thickness direction.

Next, the surface of the solid electrolyte layer 31 is coated with a conductive paste containing a conductive filler to form the first conductor layer 32A provided on the surface of the solid electrolyte layer 31. Subsequently, the surface of the first conductor layer 32A is coated with a metal paste containing a metal filler to form the second conductor layer 32B provided on the surface of the first conductor layer 32A. In the above-described manner, the conductor layer 32 including the first conductor layer 32A and the second conductor layer 32B is formed. Thus, a solid electrolytic capacitor sheet can be obtained.

Next, a resin sheet is stuck on each of both main surfaces of the solid electrolytic capacitor sheet to form the sealing layer 50 covering the corresponding conductor layer 32. Thus, a solid electrolytic capacitor array sheet is produced.

Next, a hole extending from the surface of the sealing layer 50 to the second conductor layer 32B in the thickness direction is provided in the sealing layer 50 by performing, for example, drill processing or laser processing. Then, the hole provided in the sealing layer 50 is filled with a conductive paste, and a heat treatment is performed to form the via conductor 70.

The via conductor 70 may be formed after or before a process of cutting the solid electrolytic capacitor array sheet.

Next, the through hole conductors 80A and 80B are formed by the above-described methods.

The through hole conductors 80A and 80B may be formed after or before the process of cutting the solid electrolytic capacitor array sheet.

Subsequently, the solid electrolytic capacitor 1 is manufactured by cutting the solid electrolytic capacitor array sheet into individual capacitor portions so as to isolate from each other.

### Embodiment 2

Unlike the solid electrolytic capacitor of Embodiment 1 of the present disclosure, in a solid electrolytic capacitor of Embodiment 2 of the present disclosure, a conductor layer is provided so as to cover at least a part of an end portion of an insulating layer.

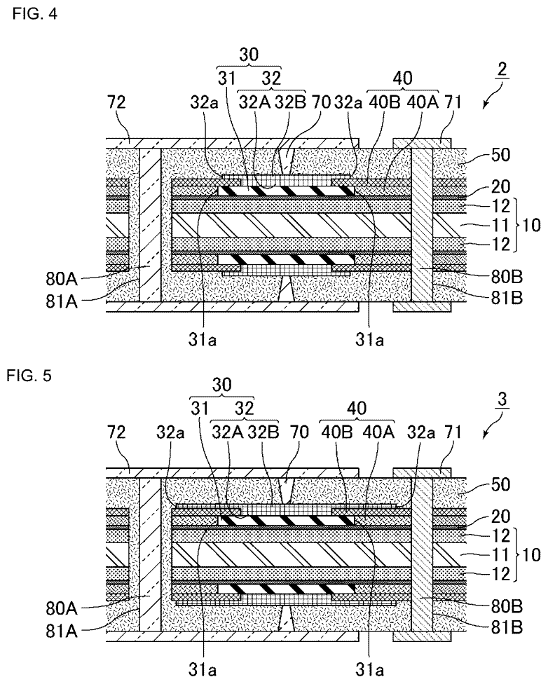

FIG. 4 is a schematic sectional view illustrating one example of the solid electrolytic capacitor of Embodiment 2 of the present disclosure.

The conductor layer 32 in the solid electrolytic capacitor 1 in FIG. 2 does not cover the end portion of the second insulating layer 40B, whereas, a conductor layer 32 in a solid electrolytic capacitor 2 in FIG. 4 is provided so as to cover at least a part of an end portion of a second insulating layer 40B. By providing the conductor layer in a way of covering at least a part of the end portion of the insulating layer, the range in which the conductor layer is formed can be further expanded. As a result, the range in which a via conductor can be provided can be further expanded, and fine pattern layout can be achieved more easily. In addition, for example, the specific resistance can be further lowered due to further expansion of the range in which the via conductor can be provided, and the element size can be further reduced by an amount equivalent to one channel of the capacitor array.

Since the provision of the conductor layer covering at least a part of the end portion of the insulating layer is sufficient in the solid electrolytic capacitor of Embodiment 2 of the present disclosure, the conductor layer may also be provided so as to cover the entire end portion of the insulating layer, and the region, on a surface of the insulating layer, in which the conductor layer is provided may be appropriately set according to a spot at which the via conductor is intended to be provided.

The solid electrolytic capacitor 2 is manufactured, for example, by changing the region in which the conductor layer 32 is provided, to cover at least a part of the end portion of the second insulating layer 40B in the above-described manufacturing method of the solid electrolytic capacitor 1.

### Embodiment 3

Unlike the solid electrolytic capacitor of Embodiment 1 of the present disclosure, in a solid electrolytic capacitor of Embodiment 3 of the present disclosure, as with the solid electrolytic capacitor of Embodiment 2 of the present disclosure, a conductor layer is provided so as to cover at least a part of an end portion of an insulating layer.

FIG. 5 is a schematic sectional view illustrating one example of the solid electrolytic capacitor of Embodiment 3 of the present disclosure.

The conductor layer 32 in the solid electrolytic capacitor 2 illustrated in FIG. 4 is provided so as to cover at least a part of the end portion of the second insulating layer 40B, and an end portion 32a of the conductor layer 32 on the opposite side from the solid electrolyte layer 31 is positioned on the inner side relative to an end portion 31a of the solid electrolyte layer 31 in plan view in the thickness direction. On the other hand, in a solid electrolytic capacitor 3 illustrated in FIG. 5, an end portion 32a of a conductor layer 32 on the opposite side from a solid electrolyte layer 31 is positioned on the outer side relative to an end portion 31a of the solid electrolyte layer 31 in plan view in the thickness direction. The range, on a surface of the insulating layer, in which the conductor layer is provided is further expanded by positioning the end portion of the conductor layer on the opposite side from the solid electrolyte layer, on the outer side relative to the end portion of the solid electrolyte layer in plan view in the thickness direction, and, while the range in which a via conductor can be provided can be further expanded, the risk of causing a short circuit due to the conductor layer 32 can be further reduced.

Since the provision of the conductor layer covering at least a part of the end portion of the insulating layer is sufficient in the solid electrolytic capacitor of Embodiment 3 of the present disclosure, the conductor layer may also be provided so as to cover the entire end portion of the insulating layer, and the region, on the surface of the insulating layer, in which the conductor layer is provided may be appropriately set according to a spot at which the via conductor is intended to be provided.

The solid electrolytic capacitor 3 is manufactured, for example, by changing the region in which the conductor layer 32 is provided, to cover at least a part of the end portion of the second insulating layer 40B in the above-described manufacturing method of the solid electrolytic capacitor 1.

### Embodiment 4

Unlike the solid electrolytic capacitor of Embodiment 1 of the present disclosure, in a solid electrolytic capacitor of Embodiment 4 of the present disclosure, an insulating layer is a single layer.

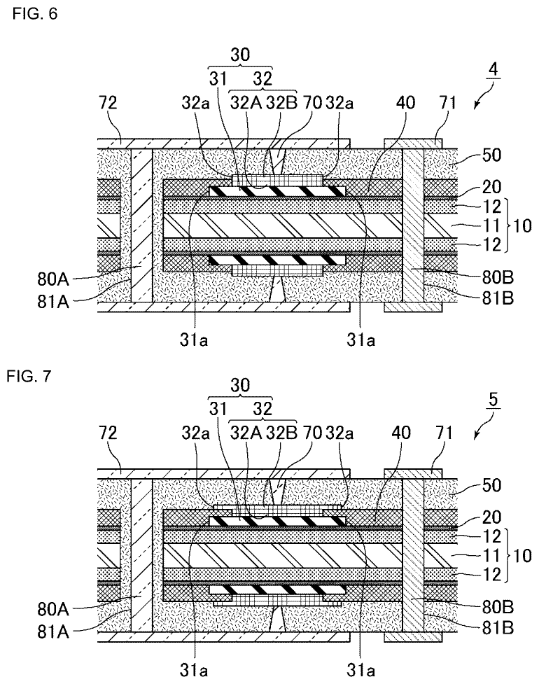

FIG. 6 is a schematic sectional view illustrating one example of the solid electrolytic capacitor of Embodiment 4 of the present disclosure.

The insulating layer 40 in the solid electrolytic capacitor 1 illustrated in FIG. 2 includes the first insulating layer 40A and the second insulating layer 40B, whereas an insulating layer 40 in a solid electrolytic capacitor 4 illustrated in FIG. 6 is a single layer. By being formed as a single layer, the insulating layer includes no joint portion, and the risk of causing a short circuit due to a conductor layer can thereby be further reduced.

The solid electrolytic capacitor 4 is manufactured by, for example, the following method.

First, an anode plate 10 including porous layers 12 on both main surfaces of a core 11, that is, the anode plate 10 including the porous layers 12 in both main surfaces thereof is prepared. Then, an oxide film to be a dielectric layer 20 is formed on a surface of each of the porous layers 12 by performing an anodic oxidation treatment on the anode plate 10.

Next, in the region to be surrounded by the insulating layer 40, a treatment of coating a surface of the dielectric layer 20 with a conductive polymer dispersion and drying is repeated plural times to form a solid electrolyte layer 31. Here, by using a high-viscosity conductive polymer dispersion, the solid electrolyte layer 31 can be formed in the region to be surrounded by the insulating layer 40.

Then, the surface of the dielectric layer 20 is coated with an insulating material to form the insulating layer 40 in a way of surrounding a cathode layer 30 and in a way of covering the entirety or a part of an end portion of the solid electrolyte layer 31 in plan view in the thickness direction.

Next, a surface of the solid electrolyte layer 31 is coated with a conductive paste containing a conductive filler to form a first conductor layer 32A provided on the surface of the solid electrolyte layer 31. Subsequently, a surface of the first conductor layer 32A is coated with a metal paste containing a metal filler to form a second conductor layer 32B provided on the surface of the first conductor layer 32A. In the above-described manner, a conductor layer 32 including the first conductor layer 32A and the second conductor layer 32B is formed.

In the rest of the process, the solid electrolytic capacitor 4 is formed in a manner similar to the solid electrolytic capacitor 1.

### Embodiment 5

Unlike the solid electrolytic capacitor of Embodiment 2 of the present disclosure, in a solid electrolytic capacitor of Embodiment 5 of the present disclosure, an insulating layer is a single layer.

FIG. 7 is a schematic sectional view illustrating one example of the solid electrolytic capacitor of Embodiment 5 of the present disclosure.

The insulating layer 40 in the solid electrolytic capacitor 2 illustrated in FIG. 4 includes the first insulating layer 40A and the second insulating layer 40B, whereas an insulating layer 40 in a solid electrolytic capacitor 5 illustrated in FIG. 7 is a single layer. By being formed as a single layer, the insulating layer includes no joint portion, and the risk of causing a short circuit due to a conductor layer can thereby be further reduced.

The solid electrolytic capacitor 5 is manufactured by, for example, the manufacturing method of the solid electrolytic capacitor 2, in a manner similar to the solid electrolytic capacitor 4.

### Embodiment 6

Unlike the solid electrolytic capacitor of Embodiment 3 of the present disclosure, in a solid electrolytic capacitor of Embodiment 6 of the present disclosure, an insulating layer is single layer.

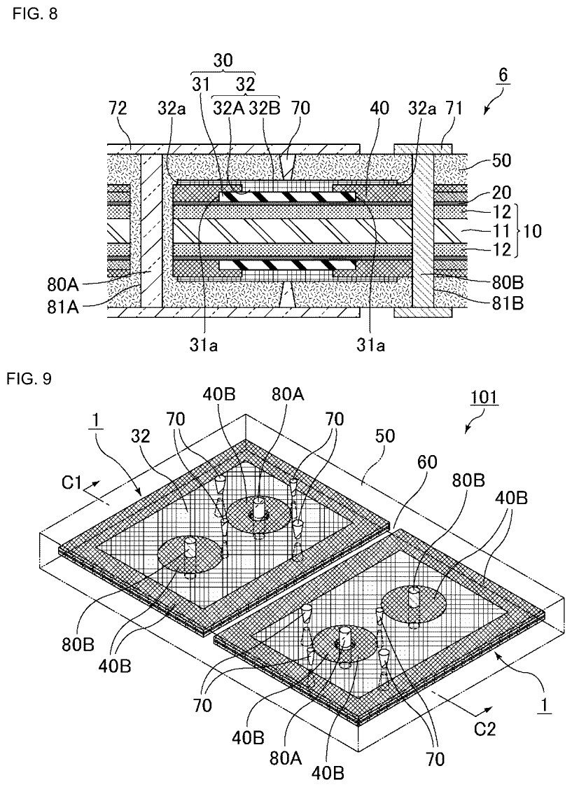

FIG. 8 is a schematic sectional view illustrating one example of the solid electrolytic capacitor of Embodiment 6 of the present disclosure.

The insulating layer 40 in the solid electrolytic capacitor 3 illustrated in FIG. 5 includes the first insulating layer 40A and the second insulating layer 40B, whereas an insulating layer 40 in a solid electrolytic capacitor 6 illustrated in FIG. 8 is a single layer. By being formed as a single layer, the insulating layer includes no joint portion, and the risk of causing a short circuit due to a conductor layer can thereby be further reduced.

The solid electrolytic capacitor 6 is manufactured by, for example, the manufacturing method of the solid electrolytic capacitor 3, in a manner similar to the solid electrolytic capacitor 4.

### Embodiment 7

A capacitor array of the present disclosure includes plural solid electrolytic capacitors of the present disclosure.

Hereinafter, one example of the capacitor array of the present disclosure is described as a capacitor array of Embodiment 7 of the present disclosure including plural solid electrolytic capacitors of Embodiment 1 of the present disclosure.

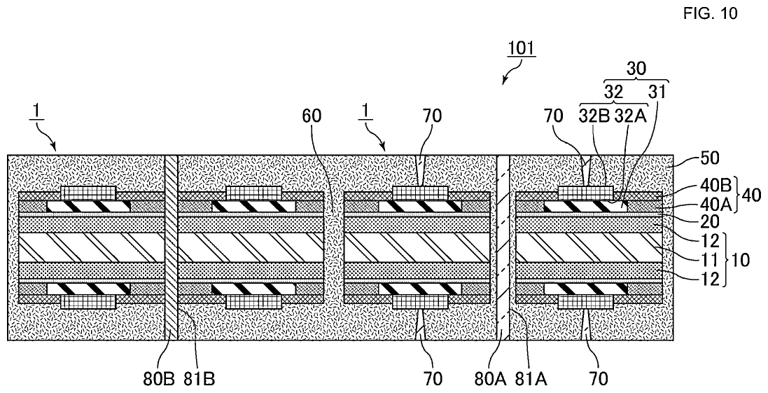

FIG. 9 is a schematic perspective view illustrating one example of the capacitor array of Embodiment 7 of the present disclosure. FIG. 10 is a schematic sectional view illustrating one example of a section taken along a line segment C1-C2 of the capacitor array illustrated in FIG. 9.

A capacitor array 101 illustrated in FIGS. 9 and 10 includes plural solid electrolytic capacitors 1 illustrated in FIG. 2. In the example illustrated in FIGS. 9 and 10, the capacitor array 101 includes two solid electrolytic capacitors 1.

In the capacitor array 101 in which the plural solid electrolytic capacitors 1 are arranged in an array, while deformation due to external force is suppressed, delamination between plural layers made of different materials, in particular, between the porous layer 12 and the solid electrolyte layer 31 hardly occurs.

In addition, by forming the capacitor array 101 by arranging the plural solid electrolytic capacitors 1 in an array, there can be provided a capacitor array having a multi-channel configuration in which the capacitance and position are optimized to respond to market demands.

Moreover, by using the capacitor array 101 in which the plural solid electrolytic capacitors 1 are arranged in an array, the plural solid electrolytic capacitors 1 can be mounted on or in a substrate efficiently.

The plural solid electrolytic capacitors 1 may be arranged into a flat plate shape or a linear shape.

The plural solid electrolytic capacitors 1 may be arranged regularly or irregularly.

The areas of the plural solid electrolytic capacitors 1 when viewed in the thickness direction may be the same with one another, may differ from one another, or may differ partially.

The planar shapes of the plural solid electrolytic capacitors 1 when viewed in the thickness direction may be the same with one another, may differ from one another, or may differ partially.

The capacitor array 101 preferably further includes an insulating portion 60 for filling a space between the plural solid electrolytic capacitors 1, here, a space between the two solid electrolytic capacitors 1.

The insulating portion 60 preferably includes a resin material.

Examples of the resin material included in the insulating portion 60 include epoxy, phenol, and polyimide.

The insulating portion 60 may further contain, in addition to the resin material, an inorganic filler of, for example, silica or alumina.

The resin material included in the insulating portion 60 may be the same as or different from the resin material included in the sealing layer 50.

The material constituting the insulating portion 60 may be the same as or different from the material constituting the sealing layer 50.

In the case where the material constituting the insulating portion 60 is the same as the material constituting the sealing layer 50, as FIGS. 9 and 10 illustrate, the sealing layer 50 and the insulating portion 60 are formed into one body, and the interface thereof does not often emerge clearly. Note that the interface between the sealing layer 50 and the insulating portion 60 may emerge clearly.

The insulating portion 60 may be a portion formed by the sealing layer 50 extending into a space between the plural solid electrolytic capacitors 1, here, a space between the two solid electrolytic capacitors 1. That is, the insulating portion 60 may be included in the sealing layer 50.

The insulating portion 60 is formed by filling a space between the plural solid electrolytic capacitors 1, here, a space between the two solid electrolytic capacitors 1 by, for example, a method in which a resin sheet is pressure-bonded or a method in which a resin paste is coated.

The capacitor array 101 is manufactured, for example, by cutting the solid electrolytic capacitor sheet into individual parts each including a desired number of capacitor portions, here, two capacitor portions, in the above-described manufacturing process of the solid electrolytic capacitor 1.

In addition to Embodiment 7 described above, the capacitor array of the present disclosure may include plural solid electrolytic capacitors of Embodiment 2 of the present disclosure, may include plural solid electrolytic capacitors of Embodiment 3 of the present disclosure, may include plural solid electrolytic capacitors of Embodiment 4 of the present disclosure, may include plural solid electrolytic capacitors of Embodiment 5 of the present disclosure, may include plural solid electrolytic capacitors of Embodiment 6 of the present disclosure, or may include plural solid electrolytic capacitors of plural embodiments.

The solid electrolytic capacitor of the present disclosure is used for, for example, a composite electronic component. Such a composite electronic component includes, for example, the solid electrolytic capacitor of the present disclosure, outer electrodes provided outside the solid electrolytic capacitor of the present disclosure and electrically connected to the anode plate and the cathode layer, and an electronic component electrically connected to the outer electrodes.

In the composite electronic component, the electronic component electrically connected to the outer electrodes may be a passive element, may be an active element, may be each of a passive element and an active element, or may be a composite of a passive element and an active element.

Examples of such a passive element include an inductor.

Examples of such an active element include a memory, a GPU (Graphical Processing Unit), a CPU (Central Processing Unit), an MPU (Micro Processing Unit), and a PMIC (Power Management IC).

When the solid electrolytic capacitor of the present disclosure is used for the composite electronic component, the solid electrolytic capacitor of the present disclosure serves as, for example, a substrate for mounting an electronic component as described above. Thus, by forming the entire solid electrolytic capacitor of the present disclosure into a sheet shape and, further, by forming the electronic component to be mounted on the solid electrolytic capacitor of the present disclosure into a sheet shape, the solid electrolytic capacitor of the present disclosure and the electronic component can be electrically connected to each other in the thickness direction by using a through hole conductor passing through the electronic component in the thickness direction. As a result, the passive element and the active element each serving as the electronic component can be formed into a configuration such as an integrated module.

For example, a switching regulator can be formed by electrically connecting the solid electrolytic capacitor of the present disclosure between a voltage regulator including a semiconductor active element and a load to which a converted direct-current voltage is supplied.

In the composite electronic component, a circuit layer may be formed on a main surface on one side of a solid electrolytic capacitor sheet in which plural solid electrolytic capacitors of the present disclosure are arranged, and the circuit layer may then be electrically connected to the passive element or the active element serving as the electronic component.

In addition, the solid electrolytic capacitor of the present disclosure may be disposed in a cavity portion provided in a substrate in advance, to be embedded therein with a resin, and a circuit layer may then be formed on the resin. A passive element or an active element serving as another electronic component may be installed in another cavity portion in the same substrate.

Alternatively, the solid electrolytic capacitor of the present disclosure may be mounted on a smooth carrier such as a wafer or glass, an outer layer portion of resin is formed, and a circuit layer may then be formed. The circuit layer may be electrically connected to the passive element or the active element serving as the electronic component.

Herein, the following content is disclosed.
<1> A solid electrolytic capacitor including: an anode plate including a porous layer at least on at least one a main surface thereof; a dielectric layer on a surface of the porous layer; a solid electrolyte layer on a surface of the dielectric layer; a conductor layer on a surface of the solid electrolyte layer; and an insulating layer on the surface of the dielectric layer, wherein the insulating layer covers at least a part of an end portion of the solid electrolyte layer in a region surrounding the solid electrolyte layer.
<2> The solid electrolytic capacitor according to the item <1>, in which, in a plan view in a thickness direction of the solid electrolytic capacitor, the part of the end portion of the solid electrolyte layer covered by the insulating layer has a shortest length from the end portion of the solid electrolyte layer to an end portion of the conductor layer among all end portions of the solid electrolyte layer.
<3> The solid electrolytic capacitor according to the item <1> or <2>, in which the solid electrolyte layer has a quadrilateral shape when viewed in a thickness direction of the solid electrolytic capacitor, and, in a plan view in the thickness direction, the insulating layer covers at least one side of the solid electrolyte layer that includes a part at which a length from the end portion of the solid electrolyte layer to an end portion of the conductor layer is the shortest among all end portions of the solid electrolyte layer.
<4> The solid electrolytic capacitor according to any one of the items <1> to <3>, in which, in a plan view in a thickness direction of the solid electrolytic capacitor, the insulating layer covers all end portions of the solid electrolyte layer.
<5> The solid electrolytic capacitor according to any one of the items <1> to <4>, in which the conductor layer covers at least a part of an end portion of the insulating layer.
<6> The solid electrolytic capacitor according to the item <5>, in which, in a plan view in a thickness direction of the solid electrolytic capacitor, an end portion of the conductor layer on an opposite side thereof from the solid electrolyte layer is on an outer side relative to the end portion of the solid electrolyte layer.
<7> The solid electrolytic capacitor according to any one of the items <1> to <6>, in which the insulating layer includes a first insulating layer on the surface of the dielectric layer in a region surrounding the solid electrolyte layer and a second insulating layer on a surface of the first insulating layer, and the second insulating layer covers at least the part of the end portion of the solid electrolyte layer.
<8> The solid electrolytic capacitor according to any one of the items <1> to <7>, further including a sealing layer covering the conductor layer.
<9> The solid electrolytic capacitor according to the item <8>, further including a through hole conductor passing through the sealing layer in a thickness direction of the solid electrolytic capacitor.
<10> A capacitor array including a plurality of the solid electrolytic capacitors according to any one of the items <1> to <9>.

### REFERENCE SIGNS LIST

1, 2, 3, 4, 5, 6 solid electrolytic capacitor
10 anode plate
11 core
12 porous layer
20 dielectric layer
30 cathode layer
31 solid electrolyte layer
31a end portion of solid electrolyte layer
31b side of solid electrolyte layer
31c side of solid electrolyte layer
32 conductor layer
32A first conductor layer
32B second conductor layer
32a end portion of conductor layer on the opposite side from solid electrolyte layer
40 insulating layer
40A first insulating layer
40B second insulating layer
50 sealing layer
60 insulating portion
70 via conductor
71 anode wiring pattern
72 cathode wiring pattern
80A, 80B through hole conductor
81A, 81B through hole
101 capacitor array

1. A solid electrolytic capacitor comprising:
an anode plate including a porous layer at least on at least one a main surface thereof;
a dielectric layer on a surface of the porous layer;
a solid electrolyte layer on a surface of the dielectric layer;
a conductor layer on a surface of the solid electrolyte layer; and
an insulating layer on the surface of the dielectric layer, wherein
the insulating layer covers at least a part of an end portion of the solid electrolyte layer in a region surrounding the solid electrolyte layer.

2. The solid electrolytic capacitor according to claim 1, wherein, in a plan view in a thickness direction of the solid electrolytic capacitor, the part of the end portion of the solid electrolyte layer covered by the insulating layer has a shortest length from the end portion of the solid electrolyte layer to an end portion of the conductor layer among all end portions of the solid electrolyte layer.

3. The solid electrolytic capacitor according to claim 1, wherein
the solid electrolyte layer has a quadrilateral shape when viewed in a thickness direction of the solid electrolytic capacitor, and,
in a plan view in the thickness direction, the insulating layer covers at least one side of the solid electrolyte layer that includes a part at which a length from the end portion of the solid electrolyte layer to an end portion of the conductor layer is the shortest among all end portions of the solid electrolyte layer.

4. The solid electrolytic capacitor according to claim 1, wherein, in a plan view in a thickness direction of the solid electrolytic capacitor, the insulating layer covers all end portions of the solid electrolyte layer.

5. The solid electrolytic capacitor according to claim 1, wherein the conductor layer covers at least a part of an end portion of the insulating layer.

6. The solid electrolytic capacitor according to claim 5, wherein, in a plan view in a thickness direction of the solid electrolytic capacitor, an end portion of the conductor layer on an opposite side thereof from the solid electrolyte layer is on an outer side relative to the end portion of the solid electrolyte layer.

7. The solid electrolytic capacitor according to claim 1, wherein
the insulating layer includes a first insulating layer on the surface of the dielectric layer in a region surrounding the solid electrolyte layer and a second insulating layer on a surface of the first insulating layer, and
the second insulating layer covers at least the part of the end portion of the solid electrolyte layer.

8. The solid electrolytic capacitor according to claim 1, further comprising a sealing layer covering the conductor layer.

9. The solid electrolytic capacitor according to claim 8, further comprising a through hole conductor passing through the sealing layer in a thickness direction of the solid electrolytic capacitor.

10. A capacitor array comprising:
a plurality of the solid electrolytic capacitors according to claim 1.

11. The capacitor array according to claim 10, wherein in at least one solid electrolytic capacitor of the plurality of solid electrolytic capacitors, in a plan view in a thickness direction of the capacitor array, the part of the end portion of the solid electrolyte layer covered by the insulating layer has a shortest length from the end portion of the solid electrolyte layer to an end portion of the conductor layer among all end portions of the solid electrolyte layer.

12. The capacitor array according to claim 10, wherein in at least one solid electrolytic capacitor of the plurality of solid electrolytic capacitors:
the solid electrolyte layer has a quadrilateral shape when viewed in a thickness direction of the capacitor array, and,
in a plan view in the thickness direction, the insulating layer covers at least one side of the solid electrolyte layer that includes a part at which a length from the end portion of the solid electrolyte layer to an end portion of the conductor layer is the shortest among all end portions of the solid electrolyte layer.

13. The capacitor array according to claim 10, wherein in at least one solid electrolytic capacitor of the plurality of solid electrolytic capacitors, in a plan view in a thickness direction of the capacitor array, the insulating layer covers all end portions of the solid electrolyte layer.

14. The capacitor array according to claim 10, wherein in at least one solid electrolytic capacitor of the plurality of solid electrolytic capacitors, the conductor layer covers at least a part of an end portion of the insulating layer.

15. The capacitor array according to claim 14, wherein in at least one solid electrolytic capacitor of the plurality of solid electrolytic capacitors, in a plan view in a thickness direction of the capacitor array, an end portion of the conductor layer on an opposite side thereof from the solid electrolyte layer is on an outer side relative to the end portion of the solid electrolyte layer.

16. The capacitor array according to claim 10, wherein in at least one solid electrolytic capacitor of the plurality of solid electrolytic capacitors:
the insulating layer includes a first insulating layer on the surface of the dielectric layer in a region surrounding the solid electrolyte layer and a second insulating layer on a surface of the first insulating layer, and
the second insulating layer covers at least the part of the end portion of the solid electrolyte layer.

17. The capacitor array according to claim 10, wherein at least one solid electrolytic capacitor of the plurality of solid electrolytic capacitors further comprises a sealing layer covering the conductor layer.

18. The capacitor array according to claim 17, wherein at least one solid electrolytic capacitor of the plurality of solid electrolytic capacitors further comprises a through hole conductor passing through the sealing layer in a thickness direction of the solid electrolytic capacitor.
